(19) United States
(12) Patent Application Publication
(10) Pub. No.: US 2017/0041783 A1
(43) Pub. Date: Feb. 9, 2017

(54) METHOD AND APPARATUS FOR BULK AUTHENTICATION OF WIRELESS SENSORS

(71) Applicant: Alcatel-Lucent USA Inc., Murray Hill, NJ (US)

(72) Inventor: Raymond B. Miller, Belmar, NJ (US)

(73) Assignee: Alcatel-Lucent USA Inc., Murray Hill, NJ (US)

(21) Appl. No.: 15/178,026

(22) Filed: Jun. 9, 2016

Related U.S. Application Data
(60) Provisional application No. 62/201,208, filed on Aug. 5, 2015.

(51) Int. Cl. H04W 12/06; H04L 9/08; H04L 29/06

(52) U.S. Cl. CPC H04W 12/06; H04L 63/0876; H04L 9/085

(57) ABSTRACT

Systems and methods for authenticating an end device include receiving an authentication request from a particular end device. The authentication request includes an identifier of the particular end device and an indication that the particular end device belongs to a set of end devices to be authenticated in bulk. In response to the indication, it is determined whether information for authenticating the end devices in the set is stored in a storage medium based on the identifier. In response to determining that the information for authenticating the end devices in the set is stored in the storage medium, the information is sent to the particular end device to authenticate the particular end device.

### CROSS-REFERENCE TO RELATED APPLICATIONS

This application claims the benefit of Provisional Application No. 62/201,208, filed Aug. 5, 2015, the disclosure of which is herein incorporated by reference in its entirety.

### BACKGROUND OF THE INVENTION

The present invention relates generally to the deployment of end devices in a coverage area, and more particularly to the bulk authentication of those end devices deployed in a coverage area.

The Internet of Things is an important set of use cases being defined for 5G (5th generation) wireless systems. End devices, such as, e.g., sensors, actuators, and cameras, have a wide range of characteristics and use cases that cover a broad range of deployment scenarios. These deployment scenarios could be remote and sparse or locally dense, could be stationary or fully mobile, or could be broadband or have low data rates.

Due to the likelihood of 5G sensors and other similar end devices being deployed in large numbers (e.g., hundreds or thousands) in a given coverage area, a method by which they can be authenticated without performing the arduous task of provisioning individual devices with identifiers and shared keys is desired. Although not necessarily a prerequisite for the invention, two characteristics that expedite this scenario are 1) the sensors in a given deployment are typically owned by the same entity, and 2) the coverage area is limited (e.g., warehouse, disaster area, etc.).

The existing 3GPP (3rd generation partnership project) LTE (long term evolution) model requires each device to be identified and authenticated individually. Each device has a unique identifier (e.g., an international mobile subscriber identify) and a shared secret key provisioned in advance, and must go through a process of mutual authentication with the wireless network. This presents a problem when a large number of devices, such as low cost battery powered sensors, are to be deployed in a given coverage area, especially when urgency is required such as in a disaster area. Each device identifier and shared secret key would need to be manually provisioned into the authentication center prior to activation.

### BRIEF SUMMARY OF THE INVENTION

In accordance with one embodiment, systems and methods for authenticating an end device include receiving an authentication request from a particular end device. The authentication request includes an identifier of the particular end device and an indication that the particular end device belongs to a set of end devices to be authenticated in bulk. In response to the indication, it is determined whether information for authenticating the end devices in the set is stored in a storage medium based on the identifier. In response to determining that the information for authenticating the end devices in the set is stored in the storage medium, the information is sent to the particular end device to authenticate the particular end device.

In accordance with one embodiment, the information for authenticating the end devices in the set includes information generated during a previous authentication of another end device of the set of end devices. The other end device may be authenticated first from the set of end devices.

In accordance with one embodiment, determining whether information for authenticating the end devices in the set is stored in the storage medium includes matching the identifier with a stored identifier associated with the information stored in the storage medium.

In accordance with one embodiment, the identifier is the same for all of the end devices in the set.

In accordance with one embodiment, the identifier is within a predetermined range of identifiers associated with the set.

In accordance with one embodiment, the particular end device includes at least one of a sensor or an actuator.

In accordance with one embodiment, the storage medium is cache memory.

These and other advantages of the invention will be apparent to those of ordinary skill in the art by reference to the following detailed description and the accompanying drawings.

### BRIEF DESCRIPTION OF THE DRAWINGS

FIG. 1 shows a high-level block diagram of an architecture for deploying end devices in a coverage area, in accordance with one or more embodiments;

FIG. 2 shows a flow diagram for authenticating an initial end device of a set of end devices, in accordance with one or more embodiments;

FIG. 3 shows a flow diagram for authenticating subsequent end devices of the same set of end devices, in accordance with one or more embodiments;

FIG. 4 shows a flow diagram for authenticating an end device, in accordance with one or more embodiments; and

FIG. 5 shows a high-level block diagram of a computer for authenticating an end device, in accordance with one or more embodiments.

### DETAILED DESCRIPTION

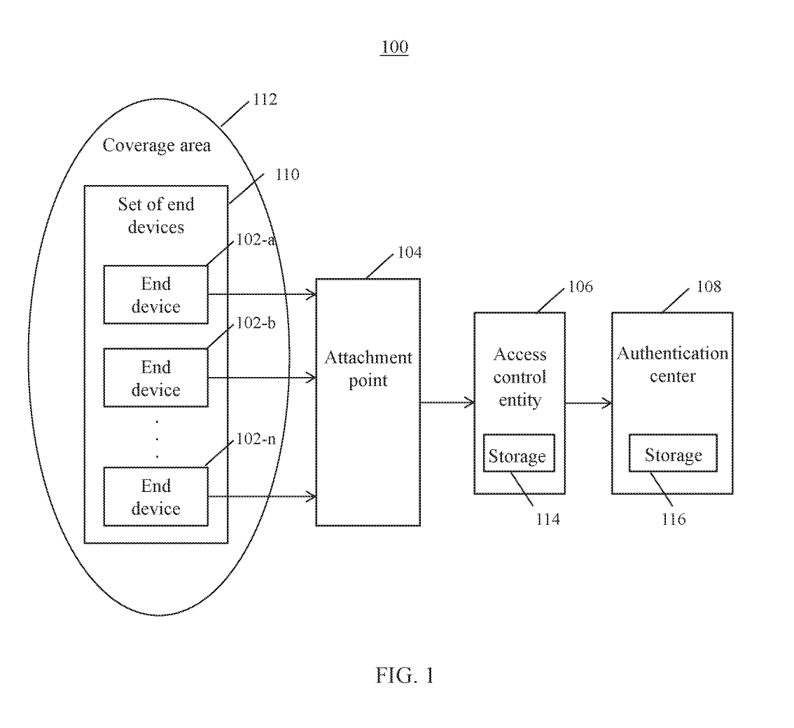

FIG. 1 shows a high-level block diagram of an architecture 100 for deploying end devices in a coverage area, in accordance with one or more embodiments. Architecture 100 includes a set 110 of end devices 102-a, 102-b, . . . , 102-n (collectively referred to as end devices 102) deployed in a coverage area 112. Each end device 102 in set 110 is provisioned for activation on attachment point 104 (e.g. a base station, or any other network element), which includes an authentication procedure by an access control entity 106 (e.g., a mobility management entity). Access control entity 106 and attachment point 104 may or may not be collocated. In one embodiment, end device 102-a is the first in the set 110 of end devices 102 to be authenticated and end devices 102-b, . . . , 102-n are subsequently authenticated after end device 102-a. End devices 102 may include, for example, sensors, actuators, or any other suitable end device. For example, end devices 102 may include one or more light sensors, temperature sensors, infrared sensors, magnetic sensors, moisture sensors, cameras, door lock actuators, etc. It should be understood that the set 110 of end devices 102 deployed in coverage area 112 may include any number of end devices 102.

End devices 102 are communicatively coupled with attachment point 104 via any secure communications interface. In one advantageous embodiment, end devices 102 include a wireless interface, such as a cellular communications interface. In another embodiment, end devices may include other secure wireless communication interfaces, such as, e.g., one or more of a Bluetooth interface, a WiFi interface, or a ZigBee interface. In other embodiments, end devices 102 may additionally or alternatively include a wired interface, such as, e.g., one or more of an Ethernet interface, a USB (Universal Serial Bus) interface, etc. Each of the end devices 102 may communicate with attachment point 104 via a same or different type of communications interface.

End devices 102 may be deployed in coverage area 112 for a number of different scenarios. Depending on the scenario, end devices 102 of set 110 may be deployed in large numbers (e.g., hundreds or thousands) in coverage area 112. Coverage area 112 may vary from stationary and dense (e.g., in a warehouse) to wide-spread and mobile but locally dense (e.g., delivery trucks). For example, in some embodiments, end devices 102 in set 110 may be deployed for monitoring a wide coverage area 112 for a particular measured property or for tracking the location of inventory, supplies, and/or equipment.

Each end device 102 of set 110 must be provisioned for activation on attachment point 104, which includes an individual authentication procedure. Conventionally, each end device in a set must be individually authenticated, which may involve generating and provisioning a shared secret key for each end device in the set. However, the individual authentication of each end device is not practical when dealing with a set having a large number of end devices.

Advantageously, embodiments described herein provide for authenticating set 110 of end devices 102 in bulk. A shared secret key is provisioned in advance in both end devices 102 and the network (e.g., authentication center 108). The shared secret key is used by authentication center 108 (which may include a subscriber database) for the generation of authentication information and other security keys and tokens. The authentication information and other security keys and tokens are stored in storage medium 116 of authentication center 108. Storage 116 may include persistent storage, such as, e.g., a disk.

End device 102-a, which is the first from the set 110 of end devices 102 to be authenticated, is fully authenticated by sending, to access control entity 106 via attachment point 104, an authentication request which includes an identifier of end device 102-a and an indication that end device 102-a is part of set 110 to be deployed in coverage area 112 and authenticated in bulk. The identifier is provisioned to be the same value (or within a predetermined range of values) for each end device 102 in set 110 and identifies the set 110 of end devices 102 to which it belongs. The authentication request may be implicit as part of the attachment/connection procedure, or as an explicit specific authentication request. Since no other end device 102 in set 110 has been authenticated yet, information for authenticating end device 102-a (e.g., keys, ciphers, and tokens) is generated by authentication center 108 based on the provisioned shared secret key as indicated by the received identifier for end device 102-a. The generated authentication information is then returned to access control entity 106. Access control entity 106 may or may not generate further authentication/security information from the information received from the authentication center 108. Access control entity 106 then stores this received and newly generated information in storage medium 114. Storage 114 may include a local persistent or semi-persistent data store, e.g. disk or memory respectively.

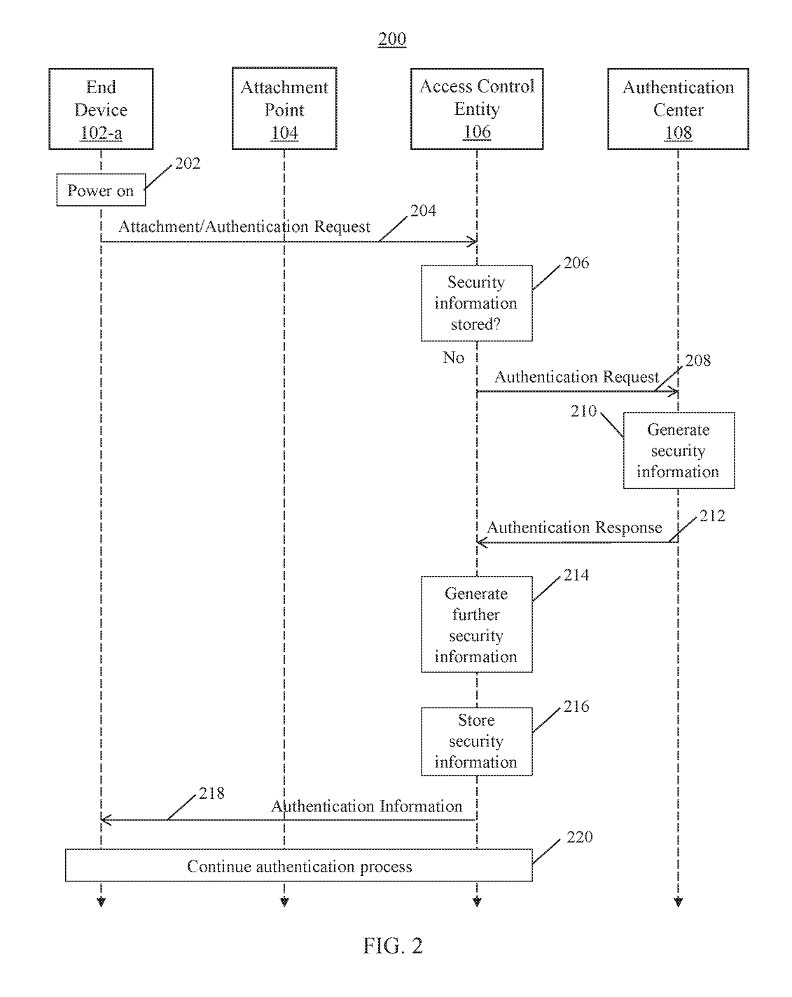

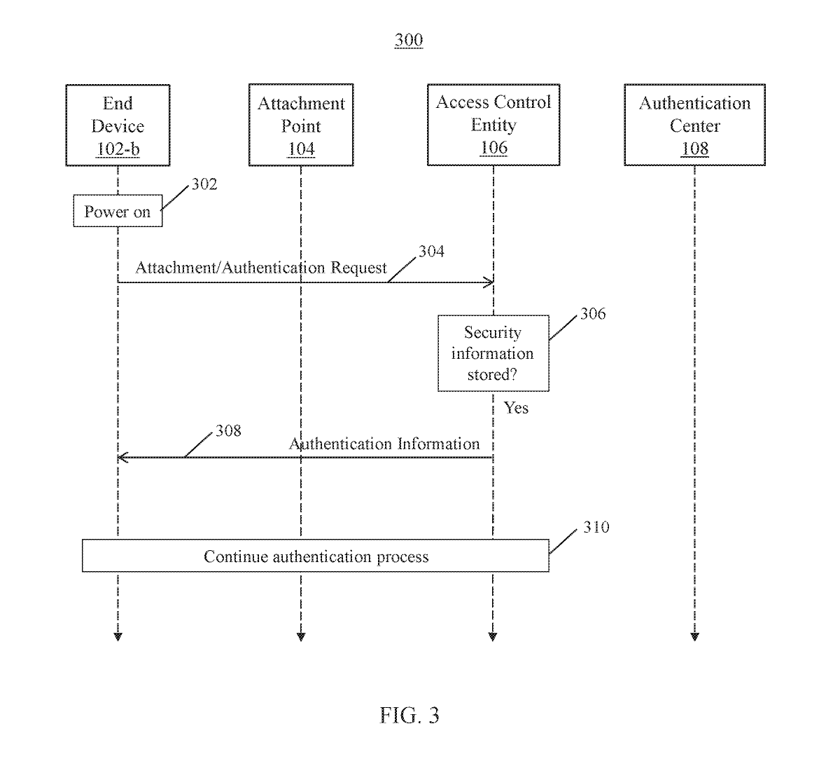

End devices 102-b, . . . , 102-n of the set 110 of end devices 102, which are authenticated subsequent to end device 102-a, are authenticated by access control entity 106 with an abbreviated authentication process by retrieving the information for authentication stored in storage 114 rather than having the information re-generated. Further details of the authentication process for the set 110 of end devices 102 are discussed at least with respect to FIGS. 2 and 3.

FIG. 2 shows a flow diagram 200 for authenticating end device 102-a of the set 110 of end devices 102, in accordance with one or more embodiments. Boxes at the top of flow diagram 200 represent elements for authenticating end device 102-a deployed in coverage area 112. Steps of flow diagram 200 are shown chronologically in time from top to bottom.

End device 102-a represents the first device of the set 110 of end devices 102 to be authenticated. Prior to the authentication procedure, a shared secret key is provisioned in both end devices 102 and the network (e.g., authentication center 108). Specifically, each end device of the set 110 of end devices 102 includes a persistent data store (not shown), such as, e.g. a universal subscriber identity module (USIM), that securely stores an identifier, such as, e.g. an international mobile subscriber identify (IMSI), that identifies the end device and a programmed/provisioned shared secret key. The programmed/provisioned shared secret key may be the same for all end devices 102 in set 110. In one advantageous embodiment, the programmed/provisioned shared secret key is programmed/provisioned into the persistent data store of end devices 102 during manufacturing (e.g., by the manufacturer), but may also be manually programmed/provisioned (or reprogrammed/reprovisioned). In some embodiments, the identifier is hardcoded into the end devices 102 and is therefore non-transferrable, thereby mitigating security concerns. Authentication center 108 includes storage medium 116, such as, e.g., a disk, to store the programmed/provisioned shared secret key.

At step 202, end device 102-a is powered on. Powering on end device 102-a may implicitly or explicitly trigger an attachment procedure for activation of end device 102-a on attachment point 104, which includes an authentication procedure. At step 204, end device 102-a sends an attachment/authentication request to access control entity 106 via attachment point 104. The attachment/authentication request includes the identifier of end device 102-a, device security capabilities of end device 102-a, and an indication that end device 102-a is part of a set (e.g. set 110) of end devices 102 to be deployed in coverage area 112 and authenticated in bulk.

At step 206, access control entity 106 receives the attachment/authentication request and, in response to the indication that end device 102-a is part of set 110 to be deployed in coverage area 112 and authenticated in bulk, determines whether information for authenticating end devices 102 in set 110 is stored in storage 114 (e.g., cache memory). For example, in one embodiment, storage 114 stores authentication/security information for authenticating a number of different sets of end devices each associated with a respective stored identifier. The authentication/security information for authenticating end devices 102 is retrieved from storage 114 as the information associated with a stored identifier matching the identifier of end device 102-a. Since end device 102-a is the first device of set 110 of end devices 102 to be authenticated, information for authenticating end devices 102 is determined to not be stored in storage 114.

At step 208, since information for authenticating end devices 102 is not stored in storage 114, access control entity 106 sends an authentication request to authentication center 108. Authentication center 108 looks up the provisioned shared secret key, stored in storage 116 based on the identifier of end device 102-a and generates the security information based on this key at step 210. The security information may include derived authentication keys, tokens, expected results, and/or any other security information. In one embodiment, authentication center 108 may generate the security information as is known in the art. An authentication response including the security information is returned to access control entity 106 at step 212. At step 214, access control entity 106 may optionally generate further security information. In addition to authentication, the security information generated at access control entity 106 and/or authentication center 108 may be used for user/device confidentiality, data integrity, etc. At step 216, access control entity 106 stores the received and newly generated security information in storage 114.

At step 218, the information for authenticating end devices 102, including the security information, is returned to end device 102-a for authenticating end device 102-a. The authentication process continues using the security information at step 220. In one embodiment, the authentication process continues as is known in the art.

In one embodiment, instead of the identifier of end device 102-a being the same for all end devices in set 102, the identifier of end device 102-a is within a known (e.g., predetermined) range of identifiers associated with set 102. In this embodiment, the identifier of end device 102-a is passed from access control entity 106 to authentication center 108 at step 208. Authentication center 108 recognizes the identifier of end device 102-a to be within the range of identifiers associated with set 102. Authentication center 108 passes the range of identifiers to access control entity 106 with the authentication response at step 212, which is stored in storage 114 at step 216.

FIG. 3 shows a flow diagram 300 for authenticating end device 102-b of the set 110 of end devices 102, in accordance with one or more embodiments. Boxes at the top of flow diagram 300 represent elements for provisioning end device 102-b in coverage area 112. Steps of flow diagram 300 are shown chronologically in time from top to bottom.

End device 102-b is provisioned for authentication subsequent to a first device being authenticated (e.g., end device 102-a as authenticated with respect to FIG. 2). While FIG. 3 is discussed herein with respect to end device 102-b, it should be understood that the steps of FIG. 3 are also applicable to end devices 102-b, . . . , 102-n that are to be authenticated subsequent to end device 102-a. As discussed above with respect to FIG. 2, end device 102-b includes a persistent data storage (e.g. USIM) that securely stores an identifier (e.g. IMSI) of end device 102-b and a programmed/provisioned shared secret key. The programmed/provisioned shared secret key may be the same for all end devices 102 in set 110. Authentication center 108 includes storage 116 to store the programmed/provisioned shared secret key.

Similar to end device 102-a discussed with respect to FIG. 2, at step 302, end device 102-b is powered on, which may implicitly or explicitly trigger an attachment procedure including a full authentication process. At step 304, end device 102-b sends an attachment/authentication request to access control entity 106 via attachment point 104. The attachment/authentication request includes an identifier of end device 102-b, device security capabilities of end device 102-b, and an indication that end device 102-b is part of set 110 of end devices 102 to be deployed in coverage area 112 and authenticated in bulk.

At step 306, access control entity 106 receives the attachment/authentication request and, in response to the indication that end device 102-b is part of set 110 to be deployed in coverage area 112 and authenticated in bulk, determines whether information for authenticating end devices 102 in set 110 is stored in the storage 114 based on the identifier of end device 102-b. In one embodiment, access control entity 106 determines whether the identifier of end device 102-b matches a stored identifier (or is within a predetermined range of identifiers) associated with authentication information. Since end device 102-a was previously authenticated by access control entity 106, information for authenticating end devices 102 in set 110 is determined to be stored in storage 114. The information for authenticating end devices 102 in set 110 may include any security information previously generated by authentication center 108 and/or access control entity 106 for authenticating end device 102-a. At step 308, information for authenticating end devices 102, including the security information, is returned to end device 102-b for authenticating end device 102-b. The authentication process continues using the security information at step 310. In one embodiment, the authentication process continues as is known in the art.

Advantageously, access control entity 106 stores authentication information generated for authenticating an initial end device 102-a in storage 114 to thereby provide for an abbreviated authentication process for subsequent end devices 102-b, . . . , 102-n in set 110 of end devices 102. As such, multiple shared keys are not required to be provisioned at authentication center 108, and the generated security information is not re-generated for authentication of the subsequent end devices 102-b, . . . , 102-n

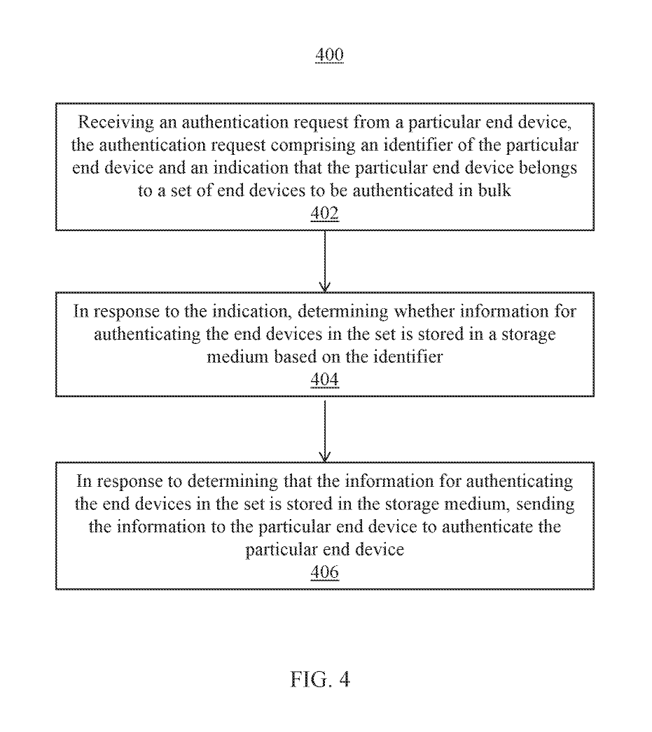

FIG. 4 shows a flow diagram of a method 400 for authenticating a particular end device, in accordance with one or more embodiments. Method 400 may be performed, for example, by an access control entity (e.g., access control entity 106).

At step 402, an authentication request (e.g., attachment/authentication request 304) is received from a particular end device (e.g., end device 102-b). The authentication request includes an identifier of the particular end device and an indication that the particular end device belongs to a set (e.g., set 110) of end devices to be authenticated in bulk. In one embodiment, the identifier is the same for all end devices in the set. In other embodiment, the identifier is within a predetermined range of identifiers associated with the set.

At step 404, in response to the indication, it is determined whether information for authenticating the end devices in the set is stored in a storage medium (e.g., storage 114). For example, in one embodiment, determining whether information for authenticating the end devices in the set is stored in the storage medium includes determining whether the identifier of the particular end device matches a stored identifier associated with authentication information stored in the storage medium.

In one embodiment, the information for authenticating the end devices in the set is generated during a previous authentication of another end device (e.g., end device 102-a) of the set of end devices. In one embodiment, the information for authenticating the end devices may be generated as is known in the art. In one embodiment, the other end device is the first end device in the set of end devices that is authenticated.

At step 406, in response to determining that the information for authenticating the end devices in the set is stored in the storage medium, the information is sent to the particular end device to authenticate the particular end device. In one embodiment, authentication may be performed as is known in the art.

Systems, apparatuses, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Systems, apparatus, and methods described herein may be implemented using computers operating in a client-server relationship. Typically, in such a system, the client computers are located remotely from the server computer and interact via a network. The client-server relationship may be defined and controlled by computer programs running on the respective client and server computers.

Systems, apparatus, and methods described herein may be implemented within a network-based cloud computing system. In such a network-based cloud computing system, a server or another processor that is connected to a network communicates with one or more client computers via a network. A client computer may communicate with the server via a network browser application residing and operating on the client computer, for example. A client computer may store data on the server and access the data via the network. A client computer may transmit requests for data, or requests for online services, to the server via the network. The server may perform requested services and provide data to the client computer(s). The server may also transmit data adapted to cause a client computer to perform a specified function, e.g., to perform a calculation, to display specified data on a screen, etc. For example, the server may transmit a request adapted to cause a client computer to perform one or more of the method steps described herein, including one or more of the steps of FIGS. 2, 3, and 4. Certain steps of the methods described herein, including one or more of the steps of FIGS. 2, 3, and 4, may be performed by a server or by another processor in a network-based cloud-computing system. Certain steps of the methods described herein, including one or more of the steps of FIGS. 2, 3, and 4, may be performed by a client computer in a network-based cloud computing system. The steps of the methods described herein, including one or more of the steps of FIGS. 2, 3, and 4, may be performed by a server and/or by a client computer in a network-based cloud computing system, in any combination.

Systems, apparatus, and methods described herein may be implemented using a computer program product tangibly embodied in an information carrier, e.g., in a non-transitory machine-readable storage device, for execution by a programmable processor; and the method steps described herein, including one or more of the steps of FIGS. 2, 3, and 4, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

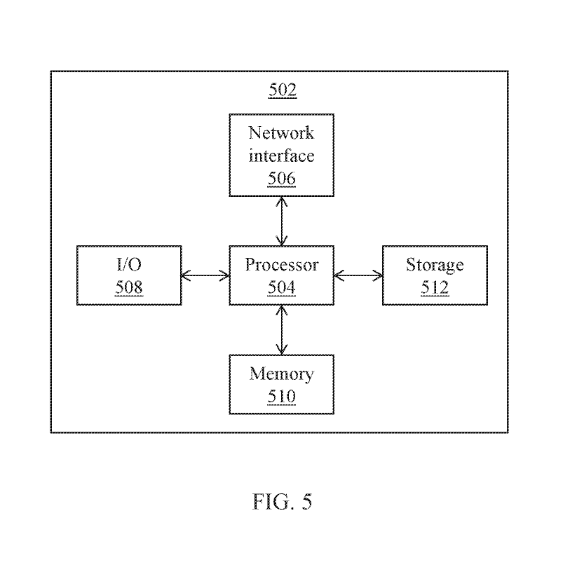

A high-level block diagram 500 of an example computer that may be used to implement systems, apparatus, and methods described herein is depicted in FIG. 5. Computer 502 includes a processor 504 operatively coupled to a data storage device 512 and a memory 510. Processor 504 controls the overall operation of computer 502 by executing computer program instructions that define such operations. The computer program instructions may be stored in data storage device 512, or other computer readable medium, and loaded into memory 510 when execution of the computer program instructions is desired. Thus, the method steps of FIGS. 2, 3, and 4 can be defined by the computer program instructions stored in memory 510 and/or data storage device 512 and controlled by processor 504 executing the computer program instructions. For example, the computer program instructions can be implemented as computer executable code programmed by one skilled in the art to perform the method steps of FIGS. 2, 3, and 4 and implement the elements of architecture 100 of FIG. 1. Accordingly, by executing the computer program instructions, the processor 504 executes the method steps of FIG. 4. Computer 502 may also include one or more network interfaces 506 for communicating with other devices via a network. Computer 502 may also include one or more input/output devices 508 that enable user interaction with computer 502 (e.g., display, keyboard, mouse, speakers, buttons, etc.).

Processor 504 may include both general and special purpose microprocessors, and may be the sole processor or one of multiple processors of computer 502. Processor 504 may include one or more central processing units (CPUs), for example. Processor 504, data storage device 512, and/or memory 510 may include, be supplemented by, or incorporated in, one or more application-specific integrated circuits (ASICs) and/or one or more field programmable gate arrays (FPGAs).

Data storage device 512 and memory 510 each include a tangible non-transitory computer readable storage medium. Data storage device 512, and memory 510, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 508 may include peripherals, such as a printer, scanner, display screen, etc. For example, input/output devices 508 may include a display device such as a cathode ray tube (CRT) or liquid crystal display (LCD) monitor for displaying information to the user, a keyboard, and a pointing device such as a mouse or a trackball by which the user can provide input to computer 502.

Any or all of the systems and apparatus discussed herein, including elements of architecture 100 of FIG. 1, may be implemented using one or more computers such as computer 502.

One skilled in the art will recognize that an implementation of an actual computer or computer system may have other structures and may contain other components as well, and that FIG. 5 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method for authenticating an end device, comprising:
receiving an authentication request from a particular end device, the authentication request comprising an identifier of the particular end device and an indication that the particular end device belongs to a set of end devices to be authenticated in bulk;
in response to the indication, determining whether information for authenticating the end devices in the set is stored in a storage medium based on the identifier; and
in response to determining that the information for authenticating the end devices in the set is stored in the storage medium, sending the information to the particular end device to authenticate the particular end device.

2. The method as recited in claim 1, wherein the information for authenticating the end devices in the set comprises information generated during a previous authentication of another end device of the set of end devices.

3. The method as recited in claim 2, wherein the other end device is authenticated first from the set of end devices.

4. The method as recited in claim 1, wherein determining whether information for authenticating the end devices in the set is stored in the storage medium comprises:
matching the identifier with a stored identifier associated with the information stored in the storage medium.

5. The method as recited in claim 1, wherein the identifier is the same for all of the end devices in the set.

6. The method as recited in claim 1, wherein the identifier is within a predetermined range of identifiers associated with the set.

7. The method as recited in claim 1, wherein the particular end device includes at least one of a sensor or an actuator.

8. A computer readable medium storing computer program instructions for authenticating an end device, which, when executed on a processor, cause the processor to perform operations comprising:
receiving an authentication request from a particular end device, the authentication request comprising an identifier of the particular end device and an indication that the particular end device belongs to a set of end devices to be authenticated in bulk;
in response to the indication, determining whether information for authenticating the end devices in the set is stored in a storage medium based on the identifier; and
in response to determining that the information for authenticating the end devices in the set is stored in the storage medium, sending the information to the particular end device to authenticate the particular end device.

9. The computer readable medium as recited in claim 8, wherein the information for authenticating the end devices in the set comprises information generated during a previous authentication of another end device of the set of end devices.

10. The computer readable medium as recited in claim 9, wherein the other end device is authenticated first from the set of end devices.

11. The computer readable medium as recited in claim 8, wherein the operation of determining whether information for authenticating the end devices in the set is stored in the storage medium comprises:
matching the identifier with a stored identifier associated with the information stored in the storage medium.

12. The computer readable medium as recited in claim 8, wherein the identifier is the same for all of the end devices in the set.

13. The computer readable medium as recited in claim 8, wherein the identifier is within a predetermined range of identifiers associated with the set.

14. The computer readable medium as recited in claim 8, wherein the particular end device includes at least one of a sensor or an actuator.

15. An apparatus for authenticating an end device, comprising:
a processor; and
a memory to store computer program instructions, the computer program instructions when executed on the processor cause the processor to perform operations comprising:
receiving an authentication request from a particular end device, the authentication request comprising an identifier of the particular end device and an indication that the particular end device belongs to a set of end devices to be authenticated in bulk;
in response to the indication, determining whether information for authenticating the end devices in the set is stored in a storage medium based on the identifier; and
in response to determining that the information for authenticating the end devices in the set is stored in the storage medium, sending the information to the particular end device to authenticate the particular end device.

16. The apparatus as recited in claim 15, wherein the information for authenticating the end devices in the set comprises information generated during a previous authentication of another end device of the set of end devices.

17. The apparatus as recited in claim 16, wherein the other end device is authenticated first from the set of end devices.

18. The apparatus as recited in claim 15, wherein the operation of determining whether information for authenticating the end devices in the set is stored in the storage medium comprises:
matching the identifier with a stored identifier associated with the information stored in the storage medium.

19. The apparatus as recited in claim 15, wherein the identifier is the same for all of the end devices in the set.

20. The apparatus as recited in claim 15, wherein the identifier is within a predetermined range of identifiers associated with the set.
